(19) United States
(12) Patent Application Publication
(10) Pub. No.: US 2006/0208149 A1
(43) Pub. Date: Sep. 21, 2006

(54) Post mounting devices

(76) Inventors: Bryan Hall, McKinney, TX (US); Robert Guthrie, McKinney, TX (US)

Correspondence Address: Steven Thrasher, 391 Sandhill Dr., Richardson, TX, 75080, US

(21) Appl. No.: 11/083,821

(22) Filed: Mar. 18, 2005

(51) Int. Cl. F16M 13/00

(52) U.S. Cl. 248/511

(57) ABSTRACT

The invention teaches mounting brackets to post having slits via a grasping member. It is emphasized that this abstract is provided to comply with the rules requiring an abstract that will allow a searcher or other reader to quickly ascertain the subject matter of the technical disclosure. It is submitted with the understanding that it will not be used to interpret or limit the scope or meaning of the claims.

### TECHNICAL FIELD OF THE INVENTION

The invention relates generally to post mountings, and more particularly to outdoor posts and mountings such as mailboxes, street signs, and traffic signs.

### PROBLEM STATEMENT

Interpretation Considerations

This section describes the technical field in more detail, and discusses problems encountered in the technical field. This section does not describe prior art as defined for purposes of anticipation or obviousness under 35 U.S.C. section 102 or 35 U.S.C. section 103. Thus, nothing stated in the Problem Statement is to be construed as prior art.

Discussion

Most common outdoor street-side signs and mailbox assemblies are mounted on posts which are either directly driven to the ground, or which are attached to ground-based platforms. For example, mountings such as mailboxes, street signs, and traffic signs are typically attached to what is effectively a smooth pipe that is either driven directly into the ground, or may be secured into the ground with cement. The attachment of the various mountings is often accomplished by drilling holes (sometimes the holes are fabricated or pre-drilled) and then attaching a mounting plate, or the mounting itself, to the post with two or more nuts. Alternatively, metal straps may be used to secure a mounting to a post. In other instances, a mounting may be affixed to a welded extension or mounting platform. Of course, other less-common means for attachment are also used to secure a mounting to a post. In any event, existing means of attaching mountings to posts suffer from a number of operational deficiencies.

For example, many of these means of attaching a mounting to a post require significant effort to place the mounting at a prescribed height--which is often dictated by federal, state, or local laws. In addition, each of the existing means of attaching a mounting to a post requires significant labor in the attachment of the mounting to a post. Further, many of the existing means of attaching a mounting to a post are not reliable, and thus a mounting may come loose after a short period of time. Accordingly, there is a need for post mounting devices and mounting assemblies that reliably secure a mounting to a post with less labor, and with more reliable mounting height placement than with exiting means for attaching a mounting to a post.

### BRIEF DESCRIPTION OF THE DRAWINGS

Various aspects of the invention, as well as an embodiment, are better understood by reference to the following detailed description. To better understand the invention, the detailed description should be read in conjunction with the drawings in which:

FIG. 1 illustrates a post.

FIGS. 2a-2d shows top-down views of selected posts.

FIGS. 3a and 3b is a close-up of a mounting bracket.

FIGS. 4a-4c illustrate selected mountings with mounting brackets.

### EXEMPLARY EMBODIMENT OF A BEST MODE

Interpretation Considerations

When reading this section (An Exemplary Embodiment of a Best Mode, which describes an exemplary embodiment of the best mode of the invention, hereinafter “exemplary embodiment”), one should keep in mind several points. First, the following exemplary embodiment is what the inventor believes to be the best mode for practicing the invention at the time this patent was filed. Thus, since one of ordinary skill in the art may recognize from the following exemplary embodiment that substantially equivalent structures or substantially equivalent acts may be used to achieve the same results in exactly the same way, or to achieve the same results in a not dissimilar way, the following exemplary embodiment should not be interpreted as limiting the invention to one embodiment.

Likewise, individual aspects (sometimes called species) of the invention are provided as examples, and, accordingly, one of ordinary skill in the art may recognize from a following exemplary structure (or a following exemplary act) that a substantially equivalent structure or substantially equivalent act may be used to either achieve the same results in substantially the same way, or to achieve the same results in a not dissimilar way.

Accordingly, the discussion of a species (or a specific item) invokes the genus (the class of items) to which that species belongs as well as related species in that genus. Likewise, the recitation of a genus invokes the species known in the art. Furthermore, it is recognized that as technology develops, a number of additional alternatives to achieve an aspect of the invention may arise. Such advances are hereby incorporated within their respective genus, and should be recognized as being functionally equivalent or structurally equivalent to the aspect shown or described.

Second, the only essential aspects of the invention are identified by the claims. Thus, aspects of the invention, including elements, acts, functions, and relationships (shown or described) should not be interpreted as being essential unless they are explicitly described and identified as being essential. Third, a function or an act should be interpreted as incorporating all modes of doing that function or act, unless otherwise explicitly stated (for example, one recognizes that “tacking” may be done by nailing, stapling, gluing, hot gunning, riveting, etc., and so a use of the word tacking invokes stapling, gluing, etc., and all other modes of that word and similar words, such as “attaching”).

Fourth, unless explicitly stated otherwise, conjunctive words (such as “or”, “and”, “including”,or “comprising” for example) should be interpreted in the inclusive, not the exclusive, sense. Fifth, the words “means” and “step” are provided to facilitate the reader's understanding of the invention and do not mean “means” or “step” as defined in §112, paragraph 6 of 35 U.S.C., unless used as “means for —functioning—” or “step for —functioning—” in the Claims section. Sixth, the invention is also described in view of the Festo decisions, and, in that regard, the claims and the invention incorporate equivalents known, unknown, foreseeable, and unforeseeable. Seventh, the language and each word used in the invention should be given the ordinary interpretation of the language and the word, unless indicated otherwise.

Of course, the foregoing discussions and definitions are provided for clarification purposes and are not limiting. In addition, equivalent structures that achieve similar ends are incorporated within the scope of the invention, and nothing in this application or prosecution waives the claims of the application to such equivalents. Words and phrases are to be given their ordinary plain meaning unless indicated otherwise.

### DESCRIPTION OF THE DRAWINGS

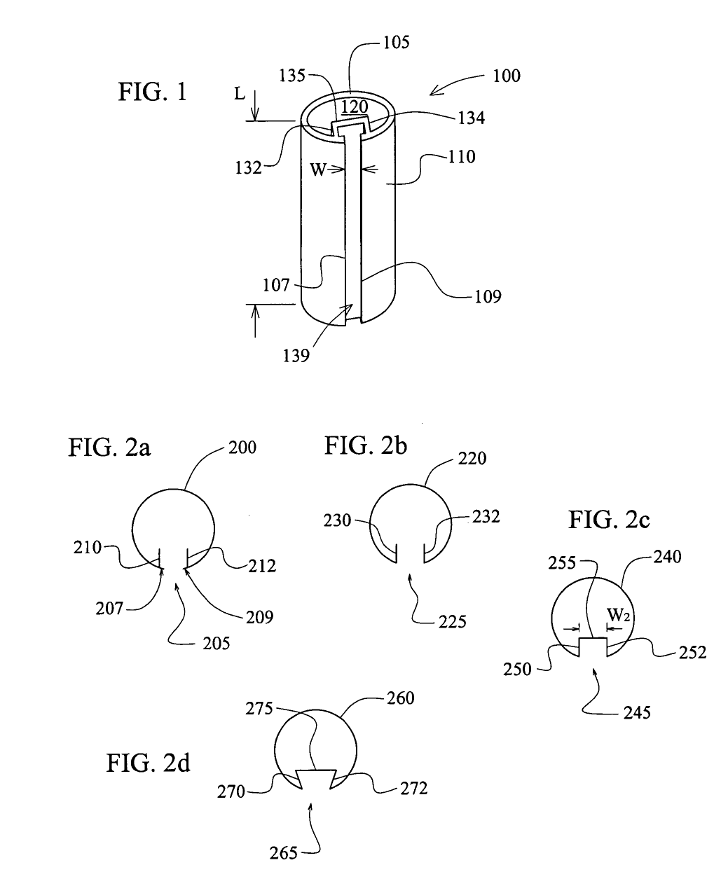

FIG. 1 illustrates a post 100 that comprises a portion of the invention. The post 100 comprises a post structure 105 having a length L, an outer surface 110, and an interior surface 120. In FIG. 1, the post 100 is illustrated as having a cylindrical outer surface 110 with a generally circular/oval cross-section (but-for a channel, discussed below). However, it will be appreciated upon reading this disclosure that a post is not limited to any particular outer surface geometry, and other outer surface shapes and/or cross-sections, such as rectangles/squares, or irregular shapes are encompassed within the scope of the invention. For ease of understanding, the post structure 105 is shown as having a smooth and consistent interior and exterior, though the post structure 105 may be ribbed or uneven, and may comprise additional structures, such as conduit.

The post 100 is preferably an aluminum post, and is preferably manufactured via aluminum-extrusion manufacture. It will also be appreciated that upon reading this disclosure that the post 100 may be made by other methods as well and may be made of other metals or other materials. For example, the post 100 may be made via plastic extrusion, or casting-type manufacture, for example. Additionally, the post 100 is in one embodiment ground-mountable, and may come in a variety of lengths, provided that the length is sufficient for the below-described mounting means. Accordingly, in one embodiment, the length L of the post is at least three feet.

The post 100 further comprises a channel running the length L of the post 100. The channel generally comprises a first side wall 132 and a second side wall 134, a back wall 135, and a slit 139 having a width W. The channel has a width definable as the maximum distance between the first side wall 132 and the second side wall 134. Although a slit 139 of constant slit width W is illustrated in FIG. 1, it is understood that it will be apparent to those of ordinary skill in the art to vary the slit width W and/or the channel width to achieve certain advantages for special various specific or general applications, and such variations are within the scope of the invention. The post also has a first lip 107 and a second lip 109, each lip 107, 109 identifiable as the post portion extending over the channel 130, such that the width W of the slit 139 is less than the width of the channel.

FIGS. 2a-2d shows top-down views of selected posts. Each of the post 200, 220, 240, 260 is shown as having generally circular structures (but-for the channels), however, as discussed above, the invention is not limited to circular structures, and other structural shapes, including those appearing from top-down views as oval, rectangular, square, trapezoidal, pentagonal, or irregular cross-sections, for example, are also within the scope of the invention. Each post 200, 220, 240, 260 comprises a first support wall 210, 230, 250, 270 coupled to an interior surface as discussed in FIG. 1, proximate to a first side of a slit 205, 225, 245, 265 and extending along the length L of the post.

Similarly, post 220, 240, 260 also comprises a second support wall 212, 232, 252, 272 coupled to the interior surface proximate to a second side of the slit 205, 225, 245, 265, and proximate to and extending along the length of the slit 205, 225, 245, 265. Although each of the support walls is shown extending partially into an interior of the post 200, 220, 240, 260, it is understood by those of skill in the art upon reading the disclosure that a support wall may extend into the interior of the post any distance necessary to secure a bracket thereto, as discussed below.

The distance between the first support wall 210, 230, 250, 270 and the second support wall 212, 232, 252, 272 may be consistent or vary, and the maximum distance between the first support wall 210, 230, 250, 270 and the second support wall 212, 232, 252, 272 defines a channel width. Accordingly, a channel width may be uniform and greater than a slit width, as shown in FIGS. 1 and FIG. 2a. In this configuration, the post may be said to have a first lip 207 and a second lip 209, each lip identifiable as the post portion (or area, both interior and exterior) lying adjacent to the slit 205 and each respective support wall 210, 212. Alternatively, a channel width may be uniform and equivalent to the slit width, as shown in FIG. 2b.

In an alternative embodiment shown in FIG. 2c, the first support wall 250 is coupled to the second support wall 252 via a channel wall 255. In one embodiment, the channel wall 255 runs the length of the post. Accordingly, a channel is generally defined as a first support wall coupled to a second support wall via a channel wall. In some discussions, one may explicitly state that the channel includes a slit, however, it should be understood that the channel includes some path to the exterior of the post.

Thus, in FIG. 2c, the first support wall 250 is coupled to the second support 252 wall via the channel wall 255, and the channel wall 255 is preferably of a uniform width, running the length of the post, although its width may also vary. However, many alternatives and variations are readily apparent to those of skill in the art upon reading this disclosure. For example, in FIG. 2d the first support wall 270 is coupled to the second support wall 272 via a channel wall 275, where the slit 265 has a width that is less than the width of the channel wall 275. In one embodiment, the channel wall 275 of FIG. 2d runs the length of the post.

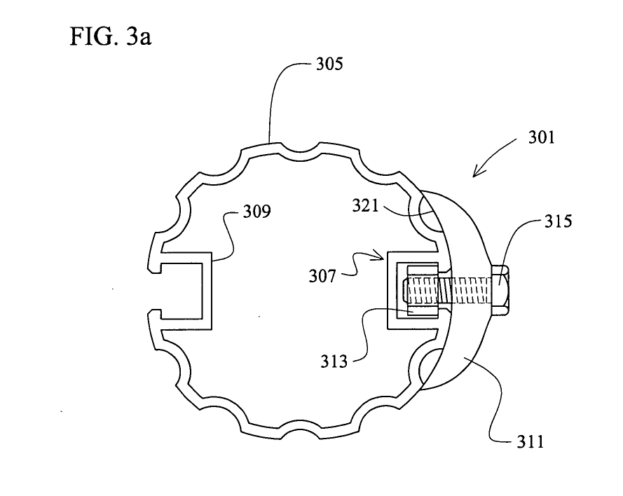

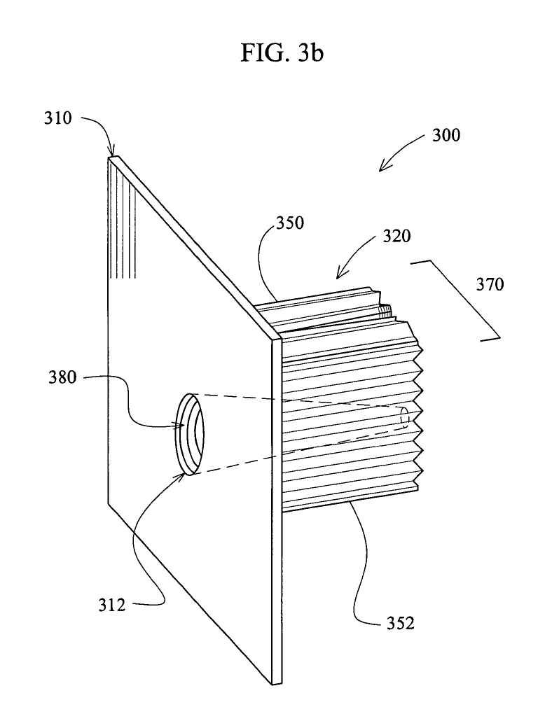

FIG. 3a is a close-up of a bracket 301 coupled to a post 305. Here, from a top-down view, the post 305 has one alternative irregular shape, and a first channel 307 and a second channel 309 that are configured similarly to the channel of FIG. 1. The bracket 301 comprises a coupling plate 311 and a grasping member that comprises a channel member such as a post nut 313, and a securing member such as a bolt 315. The post nut 313 is sized to accept the threads of the bolt 315, and is sized and placed in a channel such that the nut 313 cannot spin in the channel 307. From another point of view, the grasping member comprises a channel member, the channel member being slidable in the slit when not fully engaged by a securing member, and the channel member being rigidly affixed in the slit when in fully engaged by the securing member. Here, fully engaged means that the bolt 315 is tightened into the nut sufficiently for the grasping member to tighten to the post 305.

The coupling plate 311 is illustrated here as having an optional contoured interior 321 to increase the surface area that couples to the post 305. However, the coupling plate 311 is may be of any shape that assists in the attaching of a sign, mailbox, or other item to the post 305. In one embodiment, the coupling plate 311 is a portion of the item being attached to the post 305, such as a mailbox support. In another embodiment, a bolt may be used as a channel member, and a nut may be used as a securing member (the positions may change such that the bolt is placed in the channel and the nut is secured to the bracket by a user). In addition, upon reading this disclosure, many alternatives for securing a bracket to a post having a channel and a grasping member are obvious to those of skill in the art, and the invention incorporates all such means known, foreseeable, and unforeseeable. Alternatively, the coupling plate 311 may be configured to accept a channel portion of an item being attached to the post 305. Additionally, although not illustrated in FIG. 3b to avoid excessive clutter, lock-washers may be employed between the channel member and the interior lip of the post, and/or the lip of the post and the securing member, as will be readily apparent to one of ordinary skill in the art upon reading the present disclosure.

FIG. 3b is a close-up of a bracket 300. The bracket 300 generally comprises a plate 310 for attaching a mounting thereto, and a grasping member 320 for securing the bracket 300 to a post. The plate 310 is preferably securely coupled to the grasping member 320 via welding at a first bracket portion 350, however, in some embodiments, a nut (not shown) or rivet (not shown) or other means may be used to expand the grasping member 320, and accordingly may also be used to secure the plate 310 to the grasping member 320. In one embodiment, the plate 310 attaches to the grasping member 320 through a hole 312 in the plate 310.

The grasping member 320 comprises an expandable portion 370, here shown as the first bracket portion 350 and a second bracket portion 352. The bracket portions 350, 352, each have a portion of a threaded funnel formed therein such that when placed together as shown in FIG. 3b, a threaded funnel 380 formed there between. Additionally, the bracket portions 350, 352 also have exterior teeth 390 that provide the bracket 300 the ability to “dig” into a channel, such as the channel of FIG. 1. Accordingly, an assembly may be created by securing a mounting bracket to a post by inserting the expandable portion into the channel of a post, and then screwing a bolt that is passed through the hole 312 into the threaded funnel 380 of the bracket 300. This causes the expandable portion 370 of the grasping member 320 to expand by pushing the bracket portions 350, 352 away from each other and into the channel, thus allowing the teeth 352 of the grasping member 320 to dig into the channel and thereby secure the bracket 300 to the post.

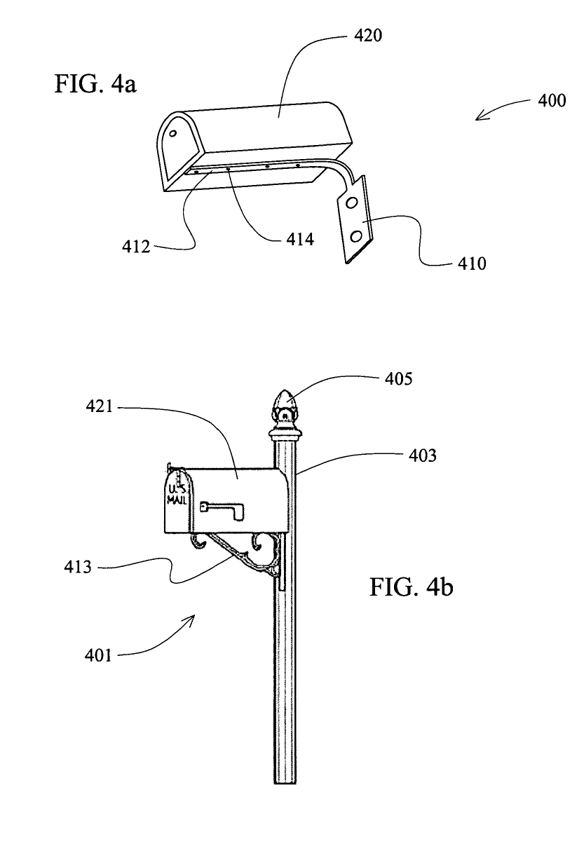

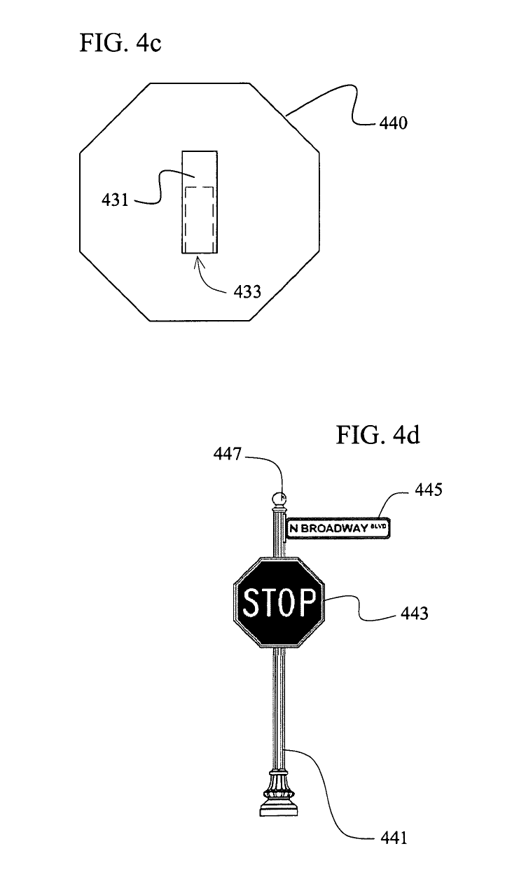

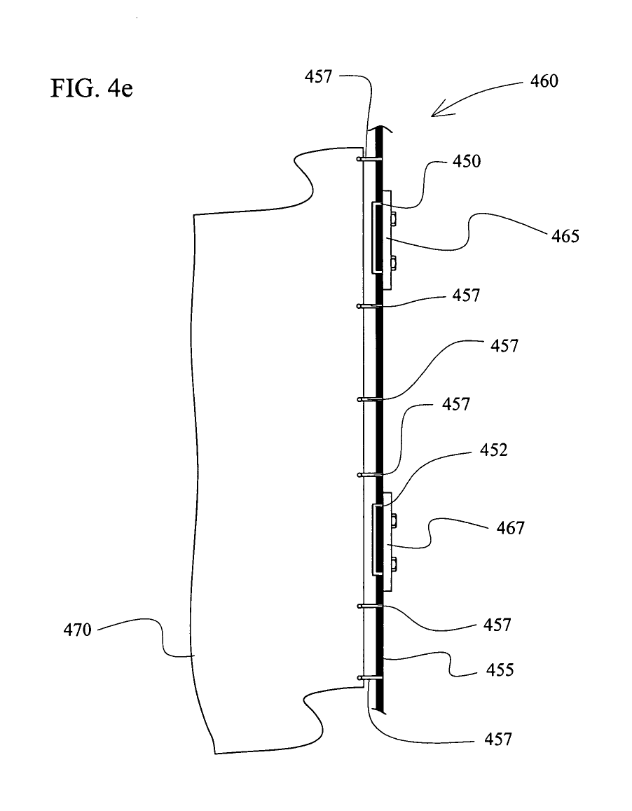

FIGS. 4a-4e illustrate selected items for mounting to a post (mountings) and post mounting combinations. FIG. 4a illustrates a mailbox mounting system 400 coupled to a mailbox 420. The mailbox mounting system 400 includes a coupling plate 410 that forms a portion of the mailbox mounting system 400, and specifically “blends” into the mailbox mounting arm 412. The mailbox mounting system 400 may be coupled to the mailbox 420 in any manner known in the mechanical arts, such as welding, mold-form construction (integral), bolts, or male/female sliding hitches, for example. In one embodiment, the mailbox mounting arm 412 includes a plurality of holes 414 so that bolts may be used to couple the mailbox 420 to the mailbox mounting system 400 as is known in the art. However, it is readily apparent to those of skill in the mechanical arts upon reading the invention that many alternatives to bolt mountings are available and all are within the scope of the invention.

In addition, the mailbox mounting arm 412 may also include a channel (not shown, but readily apparent to those of skill in the art upon reading this disclosure), configured according to the teachings of the post channels discussed above, that runs approximately horizontally a portion of the mailbox mounting's length so that brackets and expandable portions as taught herein may be used to attach or hang items to the mailbox mounting system 400. In one such embodiment, a banner may be hung from the channel of the mailbox mounting system 400, which could include a street name and house number, a wedding announcement, a party announcement, or a birth announcement, for example.

FIG. 4b illustrates one embodiment of a mailbox mounting system 401 having an ornamental mailbox mounting arm 413 that supports a mailbox 421. Here, the mailbox mounting system 400 couples to a post 403 having an ornamental cap 405 preferably in a manner taught in the discussion of FIG. 3a. However, it is understood that any attachment consistent with the teachings herein is within the scope of the invention. Attaching the mailbox mounting system 400 to the post 403 according to the teachings of the invention allows for easily adjusting the height of the mailbox to be consistent with federal, state, or local regulatory schemes, regardless of the height of the post 403 (so long as the post is at least as high as the minimum regulatory height).

FIG. 4c shows a sign mounting system 430, which here resembles a common United States stop sign. Accordingly, the signpost mounting system 430 may be used to attach any type of sign to the post, including street signs or traffic signs, for example. The signpost mounting system 430 includes a bracket sleeve 431 that is coupled to the sign 440 in any manner known in the mechanical arts, such as welding, mold-form construction (integral), bolts, or male/female sliding hitches, for example. From FIG. 4c, it is obvious to those of skill in the mechanical arts that the bracket sleeve 431 has a hollow interior, which opens to a bottom portion 433 of the bracket sleeve 431. Accordingly, the sign 440 may be mounted to a post merely by first mounting a bracket, such as those shown in FIGS. 3a and 3b, for example, to a post such as those shown in FIGS. 1 and 2a-2d, and then sliding the bracket sleeve 431 over the bracket. Of course, those of skill in the mechanical arts will recognize that the bracket used in this configuration will need to have an upper-extended portion that is adapted to mate with the bracket sleeve 431.

FIG. 4dshows a post 441 with a street sign 445 and a stop sign 445 mounted thereto. Here, it will be appreciated that the post 441 will be recognized as having at least two channels at approximately 90-degrees to each other. As channel nuts will need to be fed into a channel from either the top or the bottom of a post, an ornamental cap 447 is coupled to the top of the pole to discourage theft of the brackets used (but not visible in FIG. 4d). Of course, sleeves may be employed that incorporate designs that discourage displacement of the sign in manners known, foreseeable and unforeseeable, and such designs are incorporated into the invention without departing from its scope.

Similarly, FIG. 4e illustrates banner mounting brackets 465, 467 coupled to a banner 470. In general, banner mounting brackets are used to attach a banner, flag, or side-mounted sign, for example, to a post. A banner mounting bracket system 460 includes a first bracket 465 and a second bracket 467, each of which is coupled to the banner 470 via a first clip 450 coupled to the first bracket 465 and a second clip 452 coupled to the second bracket 467. Of course, any manner of attaching a banner to a bracket known in the mechanical arts is substitutable. For example, the banner 470 illustrated in FIG. 4c is not coupled directly to the first clip 450 or the second clip 452, but rather a dowel 455 is coupled to the clips 450, 452, and the dowel 455 supports the banner 470 via a plurality of banner rings 457.

Accordingly, an assembly (whether a mailbox assembly, signpost assembly, banner assembly, lighting assembly or similar structure) uses the above teachings to couple a mounting bracket to a post. Thus, a mailbox assembly couples a post to a mailbox mounting bracket via a slit in the post and the bracket's grasping member. Additionally, in one embodiment, the expandable portion is slidable in the post slit when in a contracted position, and is rigidly affixed in the slit when in an expanded position (as discussed above, and in equivalents). Other assemblies, including banner assemblies, sign assemblies, and light assemblies, for example, couple to the post in similar manners, as is readily apparent to those of skill in the art upon reading the disclosure.

The teachings of the invention can be applied to other post mountings. For example, a streetlight may be coupled to a mounting bracket. Accordingly, the streetlight is electrically coupled to wiring maintained in the post. Although such a configuration is not illustrated in the present disclosure, such a design is readily understood by those of ordinary skill in the art upon reading this disclosure.

Of course, it should be understood that the order of the acts of the algorithms discussed herein may be accomplished in different order depending on the preferences of those skilled in the art, and such acts may be accomplished as software. Furthermore, though the invention has been described with respect to a specific preferred embodiment, many variations and modifications will become apparent to those skilled in the art upon reading the present application. It is therefore the intention that the appended claims and their equivalents be interpreted as broadly as possible in view of the prior art to include all such variations and modifications.

I Claim:

1. A mailbox assembly, comprising:
a post, the post comprising
a length,
an outer surface, and
an interior surface,
the post further comprising
a slit running the length of the post, the slit having a first side and a second side,
a first support wall coupled to the interior surface proximate to the first side of the slit, and extending along the length of the first side of the slit,
a second support wall coupled to the interior surface proximate to the second side of the slit, and extending along the length of the second side of the slit,
the maximum distance between the first support wall and the second support wall defining a channel width;
the maximum distance between the first side of the slit and the second side of the slit defining a slit width; and
a mailbox mounting bracket securely coupled to a portion of the slit via a grasping member.

2. The assembly of claim 1 wherein the grasping member comprises an expandable portion, the expandable portion being slidable in the slit when in a contracted position, and being rigidly affixed in the slit when in an expanded position.

3. The assembly of claim 1 wherein the channel width is uniform and equivalent to the slit width.

4. The assembly of claim 1 wherein the channel width is uniform and is greater than a slit width.

5. The assembly of claim 1 wherein the first support wall is coupled to the second support wall via a channel wall, and the channel wall runs the length of the post.

6. The assembly of claim 1 wherein the first support wall is coupled to the second support wall via a channel wall, the slit width is less than the width of the channel wall, and the channel wall runs the length of the post.

7. The assembly of claim 1 wherein the first support wall is coupled to the second support wall via a channel wall, the channel wall of a uniform width, and the channel wall runs the length of the post.

8. The assembly of claim 1 wherein the post is an aluminum extrusion post.

9. The assembly of claim 1 wherein the post is at least three feet in length so that he post is ground-mountable.

10. The assembly of claim 1 further comprising a mailbox coupled to the mailbox mounting bracket.

11. The assembly of claim 1 wherein the post has a rectangular cross-section.

12. The assembly of claim 1 wherein the post has an oval cross-section.

13. The assembly of claim 1 wherein the post has an irregular cross-section.

14. The assembly of claim 1 wherein the grasping member comprises a channel member, the channel member being slidable in the slit when not fully engaged by a securing member, and the channel member being rigidly affixed in the slit when in fully engaged by the securing member.

15. A sign-post assembly, comprising:
a post, the post comprising
a length,
an outer surface, and
an interior surface,
the post further comprising
a slit running the length of the post, the slit having a first side and a second side,
a first support wall coupled to the interior surface proximate to the first side of the slit, and extending along the length of the first side of the slit,
a second support wall coupled to the interior surface proximate to the second side of the slit, and extending along the length of the second side of the slit,
the maximum distance between the first support wall and the second support wall defining a channel width;
the first support wall is coupled to the second support wall via a channel wall, and the channel wall runs the length of the post
the maximum distance between the first side of the slit and the second side of the slit defining a slit width; and
a signpost mounting bracket securely coupled to a portion of the slit via a grasping member.

16. The assembly of claim 15 wherein the post is an aluminum extrusion post.

17. The assembly of claim 15 further comprising a street sign coupled to the mounting bracket.

18. The assembly of claim 15 further comprising a traffic sign coupled to the mounting bracket.

19. The assembly of claim 15 further comprising a streetlight coupled to the mounting bracket, the streetlight electrically coupled to wiring maintained in the post.

20. A banner post assembly, comprising:
a post, the post comprising
a length,
an outer surface, and
an interior surface,
the post further comprising
a slit running the length of the post, the slit having a first side and a second side,
a first support wall coupled to the interior surface proximate to the first side of the slit, and extending along the length of the first side of the slit,
a second support wall coupled to the interior surface proximate to the second side of the slit, and extending along the length of the second side of the slit,
the maximum distance between the first support wall and the second support wall defining a channel width;
the first support wall is coupled to the second support wall via a channel wall, and the channel wall runs the length of the post
the maximum distance between the first side of the slit and the second side of the slit defining a slit width; and
a banner mounting bracket securely coupled to a portion of the slit via a grasping member.
